(19) United States
(12) Patent Application Publication
(10) Pub. No.: US 2012/0319826 A1
(43) Pub. Date: Dec. 20, 2012

(54) Power Line Data Communication Using Current Modulation

(75) Inventor: Fredrick J. Potter, Trumbauersville, PA (US)

(73) Assignee: ASTRONICS ADVANCED ELECTRONIC SYSTEMS CORP., Redmond, WA (US)

(21) Appl. No.: 13/159,769

(22) Filed: Jun. 14, 2011

(51) Int. Cl. G05B 11/01

(52) U.S. Cl. 340/12.33

(57) ABSTRACT

A system and a method effective to transmit information about a load that draws a load current to a recipient. The system includes a sensor effective to generate a first signal containing information about the load and a reference second signal. A first device calculates a ratio of the first signal to the second signal and converts that ratio into a binary number. A second device converts 0 members of the binary number to a first data current and 1 members of the binary number into a second data current that is different from the first data current. A common electrical line transmits a total current that is a sum of the load current plus the first data current or a sum of the load current plus the second data current. The recipient communicates with the common electrical line and converts current modulations to the binary number and the binary number to the information.

### U.S. GOVERNMENT RIGHTS

The invention was made with U.S. Government support under contract (BAA) DTFACT-09-R-00020 awarded by the Federal Aviation Administration. The U.S. Government has certain rights in the invention.

### CROSS REFERENCE TO RELATED APPLICATION(S)

N.A.

### BACKGROUND OF THE INVENTION

1. Field of the Invention

This invention relates to communication of data over a power feeder, and more particularly to communication of sensor data over the power feeder to the sensor.

2. Description of the Related Art

It is often useful to receive a continuous stream of data regarding the operation of an electrical device or system, for example, the positioning of a load actuator on an aircraft. A sensor adjacent the load actuator detects its position and generates an electrical signal corresponding to that pulse. This electrical signal is then transmitted to a microprocessor or other control device for either data storage or to signal the load actuator to make an adjustment in position. Transmission of the electrical signal may be by separate dedicated signal lines. However, separate signal lines increase the cost and complexity of a system. In a crowded environment, such as an aircraft bulkhead, there may be limited space for additional signal lines.

It is known to transmit data along the same lines as provide power to the actuator. Typically, the data is represented as a voltage fluctuation. However, power lines connecting a DC power source to a load have very low impedance and minimize voltage fluctuations. The lines must be heavily filtered to raise the impedance sufficiently to detect voltage fluctuations.

U.S. Pat. No. 7,304,567 to Canfield discloses a method to communicate control signals over a vehicle power bus. A current load coupled to a power source is modulated by an information signal. The resultant current changes cause voltage fluctuations that mirror the current changes. A microprocessor senses and decodes the voltage fluctuations. U.S. Pat. No. 7,304,567 is incorporated by reference herein in its entirety.

### BRIEF SUMMARY

In one embodiment of the disclosure, there is disclosed a system that is effective to transmit information about a load that draws a load current to a recipient. This system includes a sensor effective to generate a first signal containing information about the load and a reference second signal. A first device calculates a ratio of the first signal to the second signal and converts that ratio into a binary number. A second device converts 0 members of the binary number to a first data current and 1 members of the binary number into a second data current that is different from the first data current. A common electrical line transmits a total current that is a sum of the load current plus the first data current or a sum of the load current plus .the second data current. The recipient communicates with the common electrical line and converts current modulations to the binary number and the binary number to the information.

In another embodiment of the disclosure, there is disclosed a method to transmit information about a load drawing a load current to a recipient. This method includes the steps of transforming the information into a binary number, transforming the binary number into pulses of a first data current and a different second data current wherein the first data current corresponds to binary 0 values and the second data current corresponds to binary 1 values, summing the load current and the first data current or the load current and the second data current to form a total current, and the recipient converting modulation of the total current into the binary number and the binary number into the information

The details of one or more embodiments of the invention are set forth in the accompanying drawings and the description below. Other features, objects and advantages of the invention will be apparent from the description and drawings, and from the claims.

### BRIEF DESCRIPTION OF THE DRAWINGS

FIG. 1 is a schematic illustrating components of the data communication system described herein.

FIG. 2 graphically illustrates utilizing current modulation to communicate data.

FIG. 3 is a schematic illustrating components of the data encoder used to modulate current in response to data signals from the load.

Like reference numbers and designations in the various drawings indicate like elements.

### DETAILED DESCRIPTION

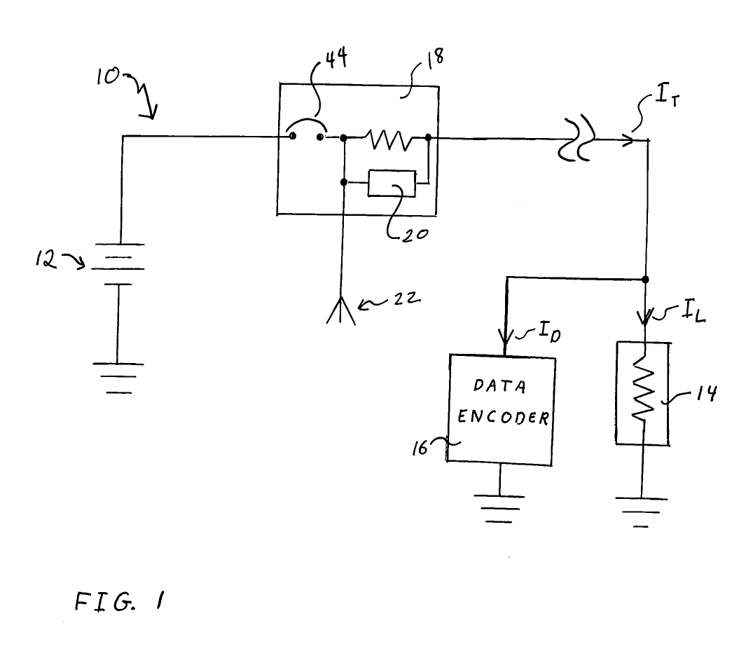

FIG. 1 schematically illustrates components of a data communication system 10 having a power source 12 electrically interconnected to a load 14. The load 14 generates data, either via internal components or via an external sensor in proximity to the load. For example, the load 14 may be an actuator attached to an aircraft rudder and the sensor determines the angle between the rudder and the vertical stabilizer. The sensor generates an electrical signal that is dependent on that angle. Typically, the power source 12 is a direct current power source, such as a 24V volt battery.

A data encoder 16 receives data signals from either the load 14 or external sensor and periodically draws a current load, I_{D}, responsive to those data signals. The load 14 also draws a current, I_{L}, such that the total current, I_{T}, is the sum of I_{D} and I_{L}.

I_{T}=I_{D}+I_{L} (1)

As I_{D} is dependent on the data signals, I_{T} will vary dependent on the data signals. Variations in I_{T}, in the form of current modulations are detected and the data signals interpreted from those modulations. I_{T} may be measured at an electronic circuit breaker 18. A microprocessor 20 within the electronic circuit breaker 18 may interpret the current modulations and respond appropriately, for example by terminating or modulating the power feed. Alternatively, the current modulations may be decoded and transmitted 22 to a remote computer or microprocessor for interpretation and response.

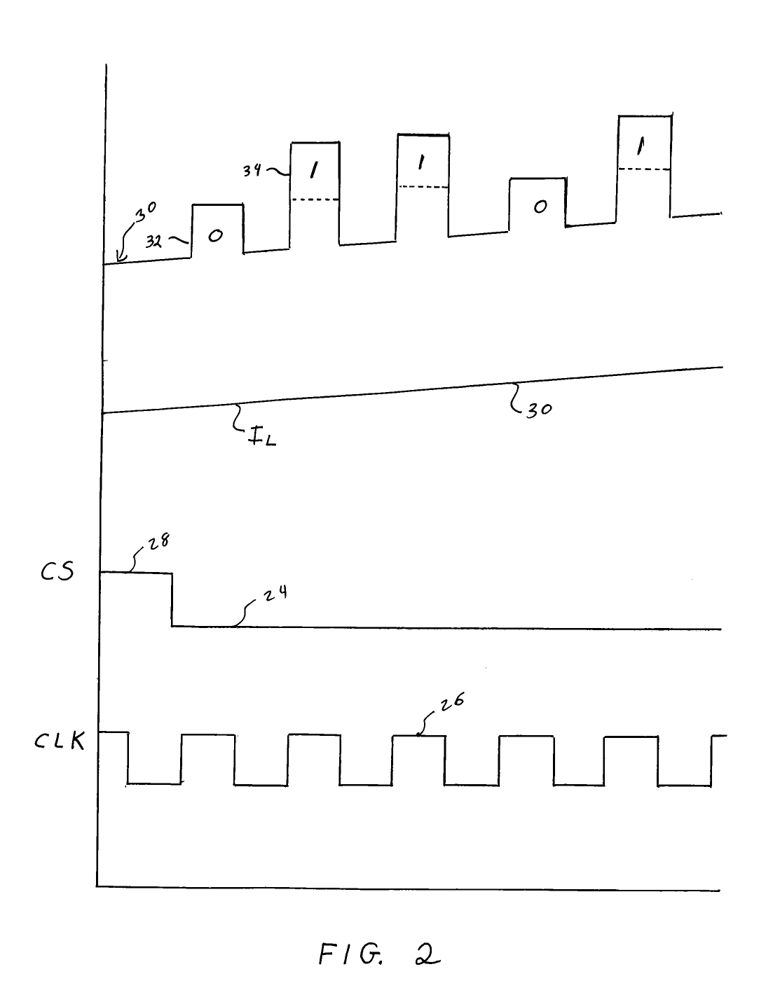

FIG. 2 graphically illustrates utilizing current modulation to communicate data. A clock, CLK, generates pulses 26 of a known periodicity, for example 100 microseconds. A counter, CS, generates a duty cycle that is on 24 for a known number of clock pulses 26 and then is off 28 for a known number of clock pulses. On 24 portion of the duty cycle is normally a standard length binary number, such as 16 pulses. The load current, I_{L}, is a value that may be changing, although the change per clock pulse is usually not excessively large. When the duty cycle is in the off portion, the data encoder does not affect I_{L} (region 30). When the duty cycle is on, the data encoder draws current at each clock pulse. The amount of current drawn may be a first data current 32 or a different (from the first) second data current 34. Typically, the second data current 34 will be twice the first data current 32. Current modulations in I_{T} therefore represent binary values of 0 or 1 and I_{T} is used to generate binary numbers that are dependent on the data coming from the load sensor. For example, in a binary 16 code, 4096 may indicate that the actuator is 100% open and 2048 may indicate the actuator is 50% open.

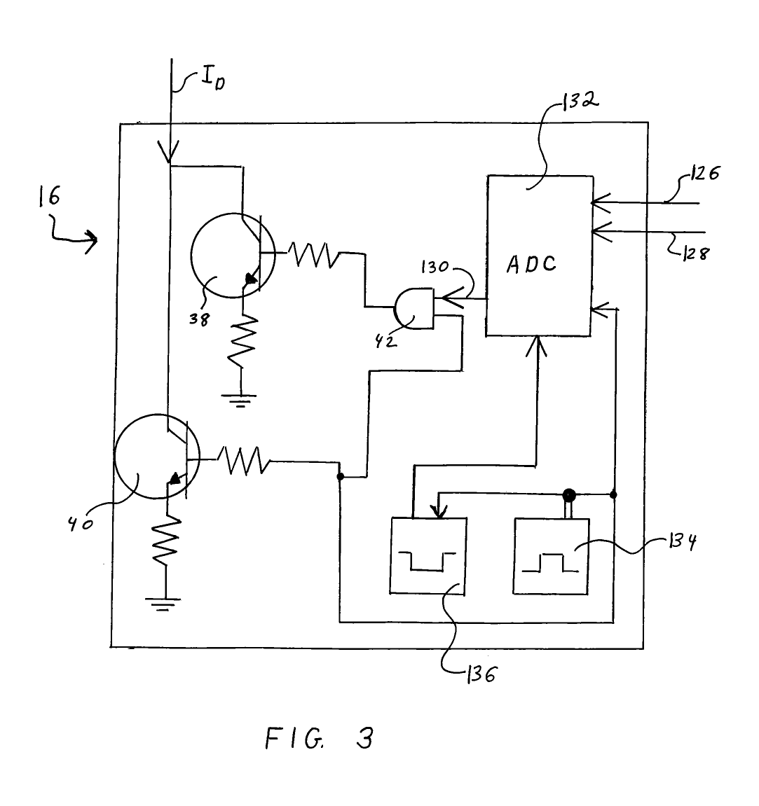

FIG. 3 is a schematic illustrating components of the data encoder 16 that modulate data current load, I_{D}, in response to data signals 126 from the load. Data signal 126 is compared to a reference signal 128 and the ratio transmitted as a digital data stream 130. Returning to the actuator example above, the data signal 126 may be a first voltage, V_{I}, that depends on the percent open of the actuator and the reference signal 128 may be a second voltage, V₂, representing the actuator fully open. An analog to digital converter (ADC) 132 converts the ratio into a digital, binary, value. If the actuator is 50% open, then the ratio V₁:V₂ would be 1:2 that for a binary 16 code would be converted to the value 2048 and transmitted via digital data stream 130.

ADC 132 has a serial peripheral interface bus (SPI) whereby the flow of digital data stream 130 is controlled by clock 134 and counter 136. Referring to FIG. 2 concurrently with FIG. 3, when the counter 136 is in off portion 28 of the duty cycle, analog data is acquired from data signal 126, compared to reference signal 28 and converted into digital data. When the counter shifts to the on portion 24 of the duty cycle, the digital data is converted into a stream of 0 (reference numeral 32) and 1 (reference numeral 34) current values which are manifest in I_{D} as data transmitting current modulations. A family of ADCs that connect to SPI without external logic are sold by Maxim Integrated Products, Inc. of Sunnyvale, Calif. as “MAXIM 2Msps/3Msps, Low-Power, Serial 12-/10-/8-Bit ADCs”.

Transistor current sources 38, 40 create “1” and “0” in synchronization with the clock 134. “And” gate 42 synchronizes the clock 134 and transistors 38, 40 by the data to be transmitted from the A to D (132). A “1” is created by activating both transistors (38 and 40) and a “0” is created by activating only transistor (40).

The current from transistors 38, 40 is summed with the load current I_{L} (FIG. 1) and measured and decoded by the Electronic Circuit Breaker 18 current measurement shunt 44 and associated microprocessor 20.

The frequency of the clock 134 and Mark (1's) and Space (0's) current pulses are chosen based on the possible variations in load current, I_{L}. It is anticipated that one millisecond (ms) clock pulses will be used for most applications, making an update of an 8 bit data word possible in less than 10 ms. This is compatible with the 100 ms sampling rate required by most analog sensors.

Alternatively, the ADC may be replaced by a microprocessor to operate transistor current sources 38, 40.

Another alternative is to use a high frequency sinusoidal current, selected to have low impact on electromagnetic interference (EMI) emissions, with the digital data encoded as frequency shifts in the carrier, or as a presence or absence of the carrier.

Still another alternative is to transmit current pulses with a duty cycle proportional to some analog value to be communicated, or current pulses having a magnitude proportional to the analog value to be communicated.

One or more embodiments of the present invention have been described. Nevertheless, it will be understood that various modifications may be made without departing from the spirit and scope of the invention. Accordingly, other embodiments are within the scope of the following claims.

What is claimed is:

1. A system effective to transmit information about a load that draws a load current to a recipient, comprising:
a sensor effective to generate a first signal containing information about said load;
a reference second signal;
a first device capable of calculating a ratio of said first signal to said second signal and converting said ratio into a binary number;
a second device that converts 0 members of said binary number to a first data current and 1 members of said binary number into a second data current that is different from said first data current;
a common electrical line for transmitting a total current that is said load current plus said first data current or said load current plus said second data current; and
said recipient coupled to said common electrical line and capable of converting current modulations to said binary number and said binary number to said information.

2. The system of claim 1 wherein said sensor is electrically coupled to said load.

3. The system of claim 1 wherein said sensor is external to said load.

4. The system of claim 1 wherein said load is an actuator attached to an aircraft component.

5. The system of claim 4 wherein said actuator is attached to a rudder and said sensor is effective to determine an angle between said rudder and a vertical stabilizer.

6. The system of claim 1 wherein said first device is an analog to digital converter.

7. The system of claim 6 wherein said second device includes first and second transistor current sources.

8. The system of claim 7 wherein said recipient is electrically coupled to said common electrical line.

9. The system of claim 7 wherein said recipient is remote from said common electrical line and receives data via wireless communication.

10. A method to transmit information about a load drawing a load current to a recipient, comprising the steps of:
transforming said information into a binary number;
transforming said binary number into pulses of a first data current and a different second data current wherein said first data current corresponds to binary 0 values and said second data current corresponds to binary 1 values;
summing said load current and said first data current or said load current and said second data current to form a total current; and
said recipient converting modulation of said total current into said binary number and said binary number into said information.

11. The method of claim 10 wherein said information is a ratio of a sensor output to a control output.

12. The method of claim 11 wherein said sensor output and said control output at voltages.

13. The method of claim 12 wherein an analog to digital converter transforms said ratio to a binary value.

14. The method of claim 13 including the step of transmitting said binary value to first and second transistor current sources.

15. The method of claim 14 wherein one of said transistor current sources is activated to generate a binary 0 value.

16. The method of claim 14 wherein both of said transistor current sources are activated to generate a binary 1 value.

17. The method of claim 14 including selecting said load to be an aircraft component.

18. The method of claim 17 including selecting said aircraft component to be a rudder and said information to be an angle between said rudder and a vertical stabilizer.
